(19) United States
(12) Patent Application Publication
(10) Pub. No.: US 2018/0165653 A1
(43) Pub. Date: Jun. 14, 2018

(54) ONLINE EDUCATION PLATFORM INCLUDING FACILITATED LEARNING

(71) Applicant: COURSERA, INC., Mountain View, CA (US)

(72) Inventors: Nathan RAHN, San Jose, CA (US); Kapeesh SARAF, Mountain View, CA (US); Melody KIM, San Francisco, CA (US); William BOWERS, San Jose, CA (US); Parth Hemant UPADHYAY, San Francisco, CA (US); Priyank CHODISETTI, Sunnyvale, CA (US)

(21) Appl. No.: 15/377,572

(22) Filed: Dec. 13, 2016

(51) Int. Cl. G06Q 10/10; H04L 12/18; G09B 5/02; G09B 5/06

(52) U.S. Cl. CPC G06Q 10/1095; H04L 12/1818; G06Q 50/2053; G09B 5/065; G09B 5/02

(57) ABSTRACT

In one general aspect, a computer-implemented method for providing facilitated learning for an online course can include enrolling, by a course application executing on a computing system, a learner in the online course, scheduling, by a facilitated learning module associated with the course application and at a first time, at least one live video conference for the online course, scheduling, by the facilitated learning module and at a second time, at least one live forum discussion for the online course, initiating, by the facilitated learning module, the at least one live video conference based on determining that a current time is the first time, and initiating, by the facilitated learning module, the at least one live forum discussion based on determining that a current time is the second time, the at least one live video conference and the at least one live forum discussion allowing participation of the learner.

### TECHNICAL FIELD

This description generally relates to providing facilitated learning including expert feedback in on-line courses.

### BACKGROUND

An online education platform provides a system that delivers online courses to learners through network-connected devices. In many cases, a learner can choose the time and place for accessing and participating in the online course. Because the learner has these options and flexibility, the learner may not experience the same classroom experience that they would if they attended the course in a classroom setting. Bringing the classroom setting to a learner's online course experience can enhance the learners experience when taking the online course.

### SUMMARY

According to one general aspect, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a computer-implemented method for providing facilitated learning for an online course can include enrolling, by a course application executing on a computing system, a learner in the online course, scheduling, by a facilitated learning module associated with the course application and at a first time, at least one live video conference for the online course, scheduling, by the facilitated learning module and at a second time, at least one live forum discussion for the online course, initiating, by the facilitated learning module, the at least one live video conference based on determining that a current time is the first time, the at least one live video conference allowing participation of the learner in the live video conference, and initiating, by the facilitated learning module, the at least one live forum discussion based on determining that a current time is the second time, the at least one live forum discussion allowing participation of the learner in the live forum discussion.

Implementations can include one or more of the following features, alone or in combination with one or more other features. For example, the method can further include generating, by the course application, a welcome communication responsive to the enrollment of the learner in the online course. The welcome communication can include at least one of confirmation of enrollment of the learner in the online course, a starting date for the online course, and a syllabus for the online course. The learner can be a member of a cohort of learners, the cohort of learners being a subset of a total number of learners enrolled in the online course. The learner can be enrolled in a particular session for the online course. The method can further include generating, by the facilitated learning module, a reminder about the scheduled at least one live video conference for the online course before initiating the at least one live video conference, and sending, by the computer system and to a computing device in communication with the computer system, the reminder for display on a display device included in the computing device. The method can further include generating, by the facilitated learning module, a reminder about the scheduled at least one live forum discussion for the online course before initiating the at least one live forum discussion, and sending, by the computer system and to a computing device in communication with the computer system, the reminder for display on a display device included in the computing device. Initiating, by the facilitated learning module, the at least one live video conference based on determining that a current time is the first time can include providing, by the computer system and to a computing device in communication with the computer system, information about the live video conference, the information allowing a learner, using the computing device, to participate in the live video conference. Initiating, by the facilitated learning module, the at least one live forum discussion based on determining that a current time is the second time can include providing, by the computer system and to a computing device in communication with the computer system, information about the live forum discussion, the information allowing a learner, interacting with the computing device, to participate in the live forum discussion.

In another general aspect, a computer-implemented method for providing facilitated learning for an online course can include receiving, by a computing device and for display in a user interface of a software application executing on the computing device, a welcome communication confirming enrollment of a learner in the online course, displaying, by the computing device and on a display device included in the computing device, the user interface including the welcome communication and a plurality of options for selection by the learner, receiving, by the computing device, an indication of the selection of an office hours option included in the plurality of options for selection by the learner, displaying, by the computing device in the user interface, a list of office hours, the list including at least one of a listing of next office hours, a listing of upcoming office hours, or a listing of past office hours, each office hour listing including a link to an offering of the office hour, receiving, by the computing device, an indication of a selection of a link to an offering of a next office hour listing, the next office hour listing being currently in session, and displaying, by the computing device and in the user interface, a facilitated learning interface for the next office hour, the facilitated learning interface allowing the learner to participate in the next office hour.

Implementations can include one or more of the following features, alone or in combination with one or more other features. For example, the learner can be associated with a mentor. The welcome communication can include a link to information about the mentor. A mentor can be assigned to the learner facilitates the next office hour. The next office hour can be a live video conference. The next office hour can be a live forum discussion. The method can further include, responsive to receiving the indication of the selection of the office hours option, sending, by the computing device and to a computer system, a request for the list of office hours, and receiving, by the computing device and from the computer system, the list of office hours.

In yet another general aspect, a non-transitory, machine-readable medium can have instructions stored thereon. The instructions, when executed by a processor, can cause a computing system to enroll a learner in an online course, schedule, at a first time, at least one live video conference for the online course, schedule, at a second time, at least one live forum discussion for the online course, initiate the at least one live video conference based on determining that a current time is the first time, the at least one live video conference allowing participation of the learner in the live video conference, and initiate the at least one live forum discussion based on determining that a current time is the second time, the at least one live forum discussion allowing participation of the learner in the live forum discussion.

Implementations can include one or more of the following features, alone or in combination with one or more other features. For example, the learner can be a member of a cohort of learners. The cohort of learners can be a subset of a total number of learners enrolled in the online course. The instructions, when executed by the processor, can further cause the computing system to assign a mentor to the learner. The mentor can facilitate the live video conference and the live forum discussion. The instructions, when executed by the processor, that cause the computing system to initiate the at least one live video conference based on determining that a current time is the first time can further include instructions that cause the computing system to provide, to a computing device in communication with the computer system, information about the live video conference. The information can allow a learner, using the computing device, to participate in the live video conference.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram of an example system for use in a facilitated learning environment.

FIG. 2 is a block diagram illustrating a facilitated learning experience.

FIG. 3 is a block diagram of an example flowchart of a learner journey for an online education platform that includes facilitated learning.

FIG. 4 is a diagram of an example user interface that provides a facilitated learning interface for an online course.

FIG. 5 is a diagram of an example user interface that provides a profile for a coach.

FIG. 6 is a diagram of an example user interface that includes a modal window.

FIG. 7 is a block diagram of an example email reminder for an online office hour.

FIG. 8 is a block diagram of an example email reminder for an online live question and answer forum.

FIG. 9 is a block diagram of an example user interface for a cohort discussion.

FIG. 10 is a block diagram of an example user interface for a course-wide discussion.

FIG. 11 is a block diagram of an example user interface that provides a list of office hours.

FIG. 12 is a block diagram of an example user interface that provides a list of learners included in a particular cohort.

FIG. 13 is a flowchart that illustrates a method for providing facilitated learning for an online course.

FIG. 14 is a flowchart that illustrates a method for providing facilitated learning for an online course when the online course is accessed by a computing device of a learner.

FIG. 15 shows an example of a generic computer device and a generic mobile computer device that can be used to implement the techniques described here.

Like reference symbols in the various drawings indicate like elements.

### DETAILED DESCRIPTION

Learners taking online courses may need to be self-motivated. Most online courses allow a learner to decide when and where they will participate in an online session. In addition, or in the alternative, many online courses provide flexible scheduling and requirements for assignments and tests. The flexibility can be beneficial and attractive to a learner but many learners could benefit from a bit more structure as that provided in a regular classroom.

Facilitated learning combines the flexibility of an online course with the benefits of a classroom. Facilitating learning provides online mentors, facilitators, and support throughout the online course experience of a learner allowing the learner to ask questions, request guidance, and otherwise obtain live guidance and support while taking the online course. The guided learning can provide a more complete and better experience for the learner by providing, for example, guidance in order for the learner to more easily and quickly grasp the course material.

Facilitated learning can provide a learner with clearer weekly course expectations by providing a mentor to guide each course session. Facilitated learning can provide a learner with access to help from classmates and/or the mentor for the course. In addition, the learner may schedule a designated time to discuss the course material with the mentor on a live basis. For example, the learner may schedule a video conference or a teleconference to occur on a weekly basis with the mentor where the learner can discuss the latest course material and ask any questions or other guidance from the mentor. In addition, the weekly meeting or conference can be used to discuss assignments the learner may be working on for completion. Facilitated learning brings to an online course experience the mentoring a learner could experience in a classroom setting. The learner can have a more fulfilling and complete online course experience because the mentor can provide expert feedback needed for the learner to get the most out of the materials, projects, and assignments for the online course.

The facilitated learning can be provided to the user in many ways. For example, as described, the learner can schedule regular (e.g., weekly) video conferences or teleconferences with a mentor who can guide the online course. This allows the learner to know what to expect each week of the online course because the mentor is guiding the class. In addition, the mentor can provide announcements about what to expect in each weekly online course offering. Discussion forums can be provided that facilitate online live discussions about course materials with other classmates taking the same online course and/or a mentor. These discussion forums can be regularly scheduled in order to provide information to learners on a timely basis. A mentor can schedule weekly online office hours where the mentor can schedule a video conference or teleconference that a learner can join in order to discuss relevant course materials. A mentor email channel can allow a learner direct access to the course mentor to ask questions and receive guidance from the mentor on a timely basis. The mentor email channel can be, for example, a particular email address for the mentor for correspondence with learners for a particular course.

The use of all of the various online communications and interactions to review and discuss relevant course material for an online course allows a learner to receive timely expert feedback. The expert feedback can enhance the experience of the learner when taking the online course.

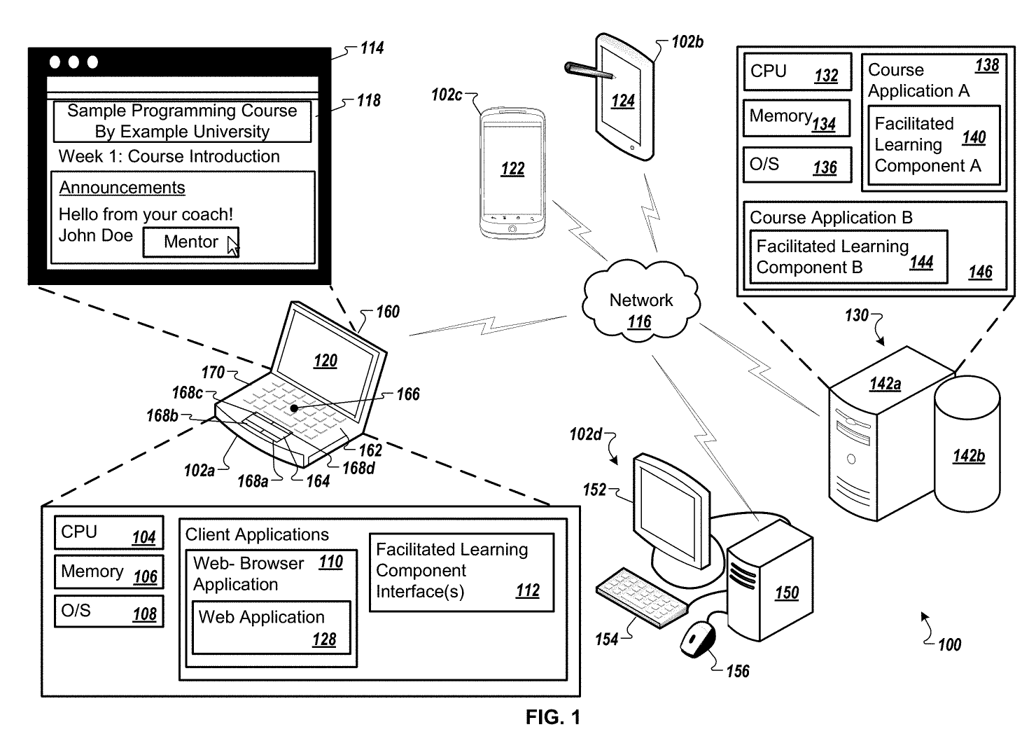

FIG. 1 is a diagram of an example system 100 for use in a facilitated learning environment. The system 100 includes a plurality of computing devices 102a-d (e.g., a laptop or notebook computer, a tablet computer, a smartphone, and a desktop computer, respectively). The system 100 includes a computer system 130 that can include one or more computing devices (e.g., a server 142a) and one or more computer-readable storage devices (e.g., a database 142b).

An example computing device 102a (e.g., a laptop or notebook computer) can include one or more processors (e.g., a client central processing unit (CPU) 104) and one or more memory devices (e.g., a client memory 106). The computing device 102a can execute a client operating system (O/S) 108 and one or more client applications, such as a web browser application 110. The web browser application 110 can execute one or more web applications (e.g., a web application 128).

The server 142a included in the computer system 130 can include one or more processors (e.g., a server CPU 132), and one or more memory devices (e.g., a server memory 134). The computing devices 102a-d can communicate with the computer system 130 (and the computer system 130 can communicate with the computing devices 102a-d) using a network 116. The server 142a can execute a server O/S 136. The server 142a can provide online course videos that can be included in (stored in) the database 142b, where the database 142b can be considered an online course repository. The server 142a can execute a course A application 138 that can provide a video of an online course (course A) to the computing devices 102a-d using the network 116. The server 142a can execute a course B application 144 that can provide a video of an online course (course B) to the computing devices 102a-d using the network 116.

In some implementations, one or more course applications can include or be associated with a respective facilitated learning component. For example, the course A application 138 can have an associated facilitated learning module (or component), facilitated learning module A 140. For example, the course B application 144 can have an associated facilitated learning module (or component), facilitated learning module B 146. FIG. 1 shows two example course applications, however, it can be understood that there can be more than two course applications or one course application. In addition or in the alternative, a course application (some of or all of the course applications) may not have an associated facilitated learning component.

The computing device 102a includes one or more facilitated learning interface modules(s) 112. Each facilitated learning interface module 112 can include software, hardware, and/or firmware that the computing device 102a can use (interface to, execute) to interface with one or more facilitated learning modules (e.g., the facilitated learning module A 140, facilitated learning module B 146) included in respective course applications (e.g., the course A application 138, the course B application 144) executing on the computer system 130, and, in particular, the server 142a. In some implementations, as shown in the example system 100, software included in the facilitated learning interface modules(s) 112 can be one or more software applications included with other client applications that the computing device 102a can execute. In some implementations, the facilitated learning interface modules(s) 112 can be one or more software applications included in (part of) the web application 128. The web browser application 110 can display a user interface (UI) (e.g., a web browser UI 114) on a display device 120 included in the computing device 102a.

In some implementations, the computing devices 102a-d can be laptop or desktop computers, smartphones, personal digital assistants, tablet computers, or other appropriate computing devices that can communicate, using the network 116, with other computing devices or computer systems. In some implementations, the computing devices 102a-d can perform client-side operations, as discussed in further detail herein. Implementations and functions of the system 100 described herein with reference to computing device 102a, may also be applied to computing device 102b, computing device 102c, and computing device 102d and other computing devices not shown in FIG. 1 that may also be included in the system 100.

The computing device 102a includes the display device 120 included in a lid portion 160 and one or more input devices included in a base portion 170. The one or more input devices include a keyboard 162, a trackpad 164, a pointer button 166, and mouse buttons 168a-d. A user can interact with one or more of the input devices to hover over text or icons included in the user interface displayed on the display device 120. In some implementations, the display device 120 can be a touchscreen. The user can also interact with the touchscreen to hover over text or icons included in the user interface displayed on the display device 120.

The computing device 102b includes a display area 124 that can be a touchscreen. The computing device 102c includes a display area 122 that can be a touchscreen. The computing device 102d can be a desktop computer system that includes a desktop computer 150, a display device 152 that can be a touchscreen, a keyboard 154, and a pointing device (e.g., a mouse 156). A user can interact with one or more input devices and/or a touchscreen to hover over text or icons included in the user interface displayed on a display device.

In some implementations, the computer system 130 can represent more than one computing device working together to perform server-side operations. For example, though not shown in FIG. 1, the system 100 can include a computer system that includes multiple servers (computing devices) working together to perform server-side operations. In this example, a single proprietor can provide the multiple servers. In some cases, the one or more of the multiple servers can provide other functionalities for the proprietor.

In some implementations, the network 116 can be a public communications network (e.g., the Internet, cellular data network, dialup modems over a telephone network) or a private communications network (e.g., private LAN, leased lines). In some implementations, the computing devices 102a-d can communicate with the network 116 using one or more high-speed wired and/or wireless communications protocols (e.g., 802.11 variations, WiFi, Bluetooth, Transmission Control Protocol/Internet Protocol (TCP/IP), Ethernet, IEEE 802.3, etc.).

In some implementations, the web browser application 110 can execute or interpret a web application 128 (e.g., a browser-based application). The web browser application 110 can include a dedicated user interface (e.g., the web browser UI 114). The web application 128 can include code written in a scripting language, such as AJAX, JavaScript, VBScript, ActionScript, or other scripting languages. The web application 128 can display a web page 118 in the web browser UI 114. The web page 118 can include a user interface for facilitated learning.

The computing device 102a can receive a video of an online video course from the computer system 130. For example, the web application 128 can display in the web browser UI 114 one or more icons representative of (associated with) respective one or more courses for selection by a user of the computing device 102a. For example, the user can select a course by placing a cursor on an icon. The user can then select the icon (e.g., click a mouse button). The selection of the icon can launch the online course. When launched, the computer system 130 can provide the video of the online course. The display device 120 can display the visual content of the video of the online course and one or more speakers (not shown) included in the computing device 102a can play the audio portion of the online course.

For example, the course A application 138 can be launched. The course A application 138 can retrieve a video of the online course A from the database 142b. The server 142a using the network 116 can provide the video of the online course A to the computing device 102a. In addition, the course A application 138 can interface with the facilitated learning module A 140 to provide a facilitated learning experience to a user of the computing device 102a. The course A application 138 using the facilitated learning module A 140 can interface to the facilitated learning interface module(s) 112 when providing the facilitated learning experience to a user of the computing device 102a. For example, the facilitated learning module A 140 can provide the necessary information for use by the facilitated learning interface module(s) 112 to display a user interface on the display device 120. A user, by way of the user interface, can provide the information needed by the facilitated learning module A 140 to complete a facilitated learning experience.

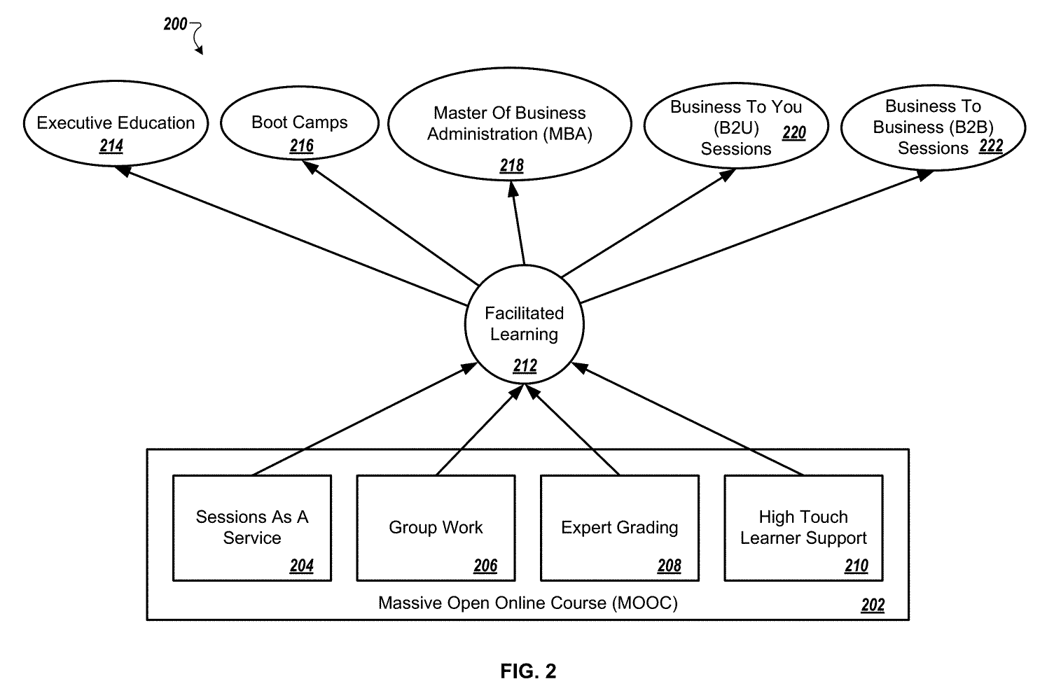

As described herein, and in further detail in FIGS. 2-14, information and data entered into one or more user interfaces provided by the facilitated learning interface module(s) 112 can be provided to the facilitated learning module A 140 when providing a facilitated learning experience to a learner taking the online course A.

The launching of the course B application 144, the providing of the online course B, the interfacing of the course B application 144 with the facilitated learning module B 146, and the interfacing of the course B application 144 (and the facilitated learning module B 146) with the facilitated learning interface module(s) 112 to provide a facilitated learning experience to a user of the computing device 102a can be performed in a similar manner as that for the course A application 138.

FIG. 2 is a block diagram illustrating a facilitated learning experience 200. The facilitated learning experience 200 can incorporate a classroom experience into an online learning experience for an online course.

A massive open online course (MOOC) 202 can include one or more sessions as a service 204, group work 206, expert grading 208, and high touch learner support 210. The MOOC 202 can be associated with a facilitated learning module (or component) 212. For example, the MOOC 202 can be the online course A and the facilitated learning module 212 can be the facilitated learning module A 140. In another example, the MOOC 202 can be the online course B and the facilitated learning module 212 can be the facilitated learning module B 146. In both examples, the MOOC 202 can be included (stored in) the database 142b. Descriptions for the online course A, the course A application 138, and the facilitated learning module A 140 described with reference to FIG. 2 can be applied to the online course B, the course B application 144, and the facilitated learning module B 146.

The sessions as a service 204 can provide each session (each class, each part) for an online course to a user. For example, referring to FIG. 1, the course A application 138 can use the sessions as a service 204 to provide each session of the online course A to the user of the computing device 102a. While interacting with each session, course A application 138 can integrate the use of group work 206 in the online course A. For example, the group work 206 can include group projects and group discussions. The course A application 138 can provide user interfaces and user communication channels to allow learners enrolled in the online course A to form project groups and/or discussion groups. The course A application 138 can allow for expert grading 208. Rather than having a peer or fellow learner grade course assessments for a learner (e.g., assignments, exams and papers), the expert grading 208 provides for an expert in the course material (e.g., a teacher, a professor, a course facilitator, a course teaching assistant) to grade the course assessments for a learner. High touch learner support 210 can provide for a multitude of different types and forms of online interactions between learners, course experts (e.g., teachers, professors, course facilitators, course teaching assistants), and administrators. The high touch learner support 210 can provide individualized support and guidance for each learner. The high touch learner support 210 can involve one-to-one online interactions between a learner and another individual who can provide the answers and support requested by the user (e.g., a course expert, another learner, a course administrator).

The MOOC 202 can provide input to the facilitated learning module 212 to facilitate the learning experience for the MOOC 202. The facilitated learning module 212 can provide one or more user experiences and options for facilitating the learning process for the MOOC 202. For example, as shown in FIG. 2, the user experiences and options can include, but are not limited to, online executive education 214, online boot camps 216, online master of business administration (MBA) 218, online business-to-you (B2U) sessions 220, and online business-to-business (B2B) sessions 222.

The facilitated learning module 212 can provide the MOOC 202 as online executive education 214. For example, the facilitated learning module 212 can customize or tailor the MOOC 202 for a specific company or organization. The facilitated learning module 212 can take the course content for the MOOC 202 and create an online boot camp 216 for the MOOC 202. For example, the facilitated learning module 212 can condense the course content for the MOOC 202 when creating the online boot camp 216. In another example, the facilitated learning module 212 can shorten the duration of the MOOC 202, making it a shorter, more intensive course offering.

In cases where the MOOC 202 content is related to business, the facilitated learning module 212 can provide the MOOC 202 as the MBA 218. The online MBA 218 can achieve a deep mastery of business strategy and leadership. The facilitated learning module 212 can provide a heavily interactive facilitated learning user experience for a business related MOOC (e.g., the MOOC 202) facilitating the creation of live global classrooms, team projects, and personal contact between individual learners and experts in the course materials.

The facilitated learning module 212 can provide the MOOC 202 as online B2U sessions 220. For example, the facilitated learning module 212 can provided a user customized facilitated learning experience for the MOOC 202. The facilitated learning module 212 can provide the MOOC 202 as online B2B sessions 222. For example, the facilitated learning module 212 can provided a facilitated learning experience for the MOOC 202 that customizes how the MOOC 202 is offered to employees of a particular business. In addition or in the alternative, the facilitated learning module 212 can provided a facilitated learning experience for the MOOC 202 that customizes how the offering of the MOOC 202 is managed by a particular business.

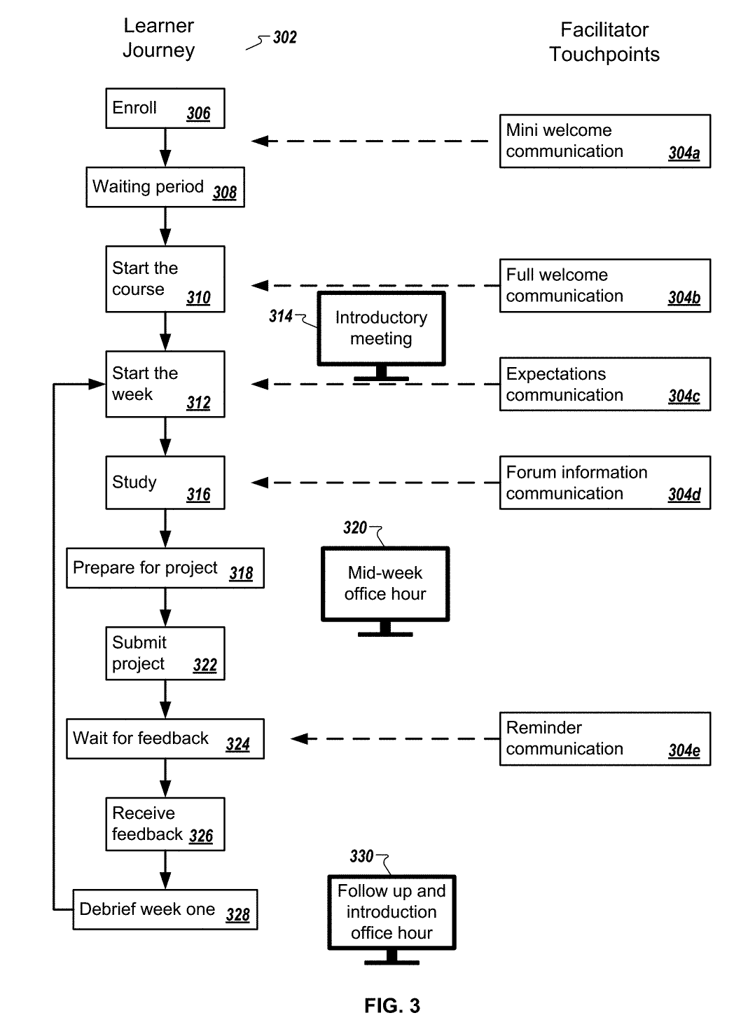

FIG. 3 is a block diagram of an example flowchart of a learner journey 302 for an online education platform that includes facilitated learning. The online education platform can be implemented as shown, for example, in FIG. 1 and FIG. 2.

FIG. 3 includes facilitator touchpoints 304a-e that occur at particular points or steps along the learner journey 302. The communications provided by the facilitator touchpoints 304a-e and to one or more learners for an online course can be provided in the form of, for example, instant messages, email messages, voicemail messages, etc. For example, referring to FIG. 1, the communications can be provided to one or more computing devices for a user such as computing devices 102a-d.

The learner journey 302 begins by a learner enrolling in an online course (block 306). For example, an online course may have many sessions and the enrollment of the learner in the online course can be for a particular session (or offering) of the online course. For example, sessions of the online course may be offered multiple times in a year (e.g., fall and spring).

Once enrolled, the learner may experience a waiting period (block 308). During the waiting period, the learner may receive a mini welcome communication from a facilitator (a mentor, a couch) at the facilitator touchpoint 304a. For example, the mini welcome communication (the mini welcome message, the mini welcome email) can confirm that the learner has been enrolled in the course and can provide the starting date for the course. In addition, the mini welcome message can provide some basic information about the course, about expectations for successful course completion, and about the facilitated learning experience that will be provided to the learner by the online course. The waiting period is a period of time that transpires between the learner enrolling in the online course and when the online course actually starts. The learner begins taking the course when the course starts (block 310).

Once the course begins, the learner may receive a full welcome communication from the facilitator at the facilitator touchpoint 304b. For example, the full welcome communication (the full welcome message, the full welcome email) can provide information about what to expect from the online course. In addition, the full welcome communication can include a course syllabus, a listing of assignments, projects, tests, etc. and their associated deadlines.

In addition, the facilitator may schedule an online video conference as an introductory meeting 314 that can include all of the learners enrolled in the online course, the facilitator, and anyone else involved in providing the course materials to the learners such as teaching assistants, administrators, expert graders, etc. The introductory meeting 314 can be scheduled after the start of the course but before the start of the first week of the course.

The learner starts the week of the online course (block 312). For example, the learner starts the first week (week one) of the online course. The learner may then receive an expectations communication from the facilitator at the facilitator touchpoint 304c. The expectations communication (the expectations message, the expectations email) can include information about what to expect during the first week of the online course. In addition, the expectations communication can outline to the learner the course syllabus for the first week of the course. The expectations communication can also include a list of projects, assignments, and evaluations that the learner may need to complete during the first week (and perhaps the first few weeks) of the online course.

The learner while participating in the first week of the online course will need to study (block 316). During this study period, the learner may receive a forum information communication from the facilitator at the facilitator touchpoint 304d regarding one or more forums that may be held during the week. The forum information communication (the forum information message, the forum information email) may outline when one or more forums will be held, how the forums will be held (e.g., one or more of an online chat, a messaging session, a video conference, a teleconference) and what to expect during the forums. For example, learners can direct questions to a repository for a forum. During the scheduled time for the forum, a facilitator for the forum can answer the questions. The questions may be answered in an online messaging question and answer session.

The learner prepares a project (block 318). The facilitator may schedule an online video conference as a mid-week office hour 320. During the mid-week office hour 320, the facilitator and the learners can review proactively where a learner may be stuck or having problems with the project. In addition, an online chat or messaging session can occur concurrent with the online video conference for the mid-week office hour 320. This allows the facilitator (and the learners) to ask and answer questions about the project in real time while also participating in the online video conference for the mid-week office hour 320.

The learner submits the completed project (block 322). The learner then waits for feedback on the project (block 324). While waiting for feedback on the project, the learner may receive a reminder communication from the facilitator at the facilitator touchpoint 304e. The reminder communication can include information regarding when grades for the project will be revealed. In addition or in the alternative, the reminder communication can include information regarding if and when the facilitator will schedule follow up office hours. The learner receives feedback about the project (block 326). The feedback can be suggested corrections to the project or suggested additional information to include in the project.

The learner is debriefed for the first week of the online course (block 328). For example, part of the learner debriefing for the first week of the online course can include a scheduled online video conference as a follow up and introduction office hour 330. The follow up and introduction office hour 330 can provide post week one follow up and an introduction to week two of the online course. During the follow up and introduction office hour 330, the facilitator and the learners can review proactively areas where many of the learners may not have done well or may have had difficulties with the project assigned during the first week (week one) of the online course. In addition or in the alternative, during the follow up and introduction office hour 330, the facilitator and the learners can cover the course materials and expectations during the second week (week two) of the online course.

Once debriefing for the first week of the online course is complete (block 328), the learner journey proceeds to start the next week of the course (block 312). As shown in FIG. 3, there are many points and milestones along the learner journey 302 where facilitator touchpoints (e.g., the facilitator touchpoints 304a-e) occur. The facilitator touchpoints 304a-e result in communications, forums, and office hours that facilitate and enhance the learning experience of the learner by providing interactions with and guidance from course facilitators and experts as well as fellow learners in the course.

As shown in FIGS. 1-3, a facilitated learning experience can provide a guided, supported, and live course experience to a learner allowing the learner to better complete and grasp the course content and materials. As shown in FIG. 3, a learner can understand what to expect during each week of the online course based on guidance by a mentor or facilitator. For example, the facilitator (or mentor) can provide the guidance in the form of weekly announcements about the online course.

The learner has access to help when needed. For example, a learner can obtain help and guidance from other learners using instant messaging or online chat sessions. A learner can receive help from the mentor within a set time frame (e.g., 12 hours, 24 hours). The help can be provided in an online discussion forum where the learner(s) and the mentor can participate live in an interactive question and answer session. For example, the forum can be an instant messaging session, an online chat session, an audio conference (e.g., a teleconference), or a video conference.

The learner can set up a scheduled time each week to communicate live with a mentor. For example, a weekly live communication session between the learner and the mentor can be in the form of weekly office hours. During these weekly office hours, the learner can contact the mentor using email communications, phone calls, instant messaging, or other types of online interactive communications.

The learner can speak directly with a mentor whenever the learner needs help with the online course content and materials. For example, the learner can be provided with a direct mentor email channel that allows the learner to directly contact the mentor whenever the learner requires assistance.

The facilitated learning experience allows a learner many opportunities using a variety of live communication methods to speak and interact with a mentor for the online course when the learner needs help with the course content and materials. The mentor can provide valuable expert feedback to the learner making the course experience a more enriching process.

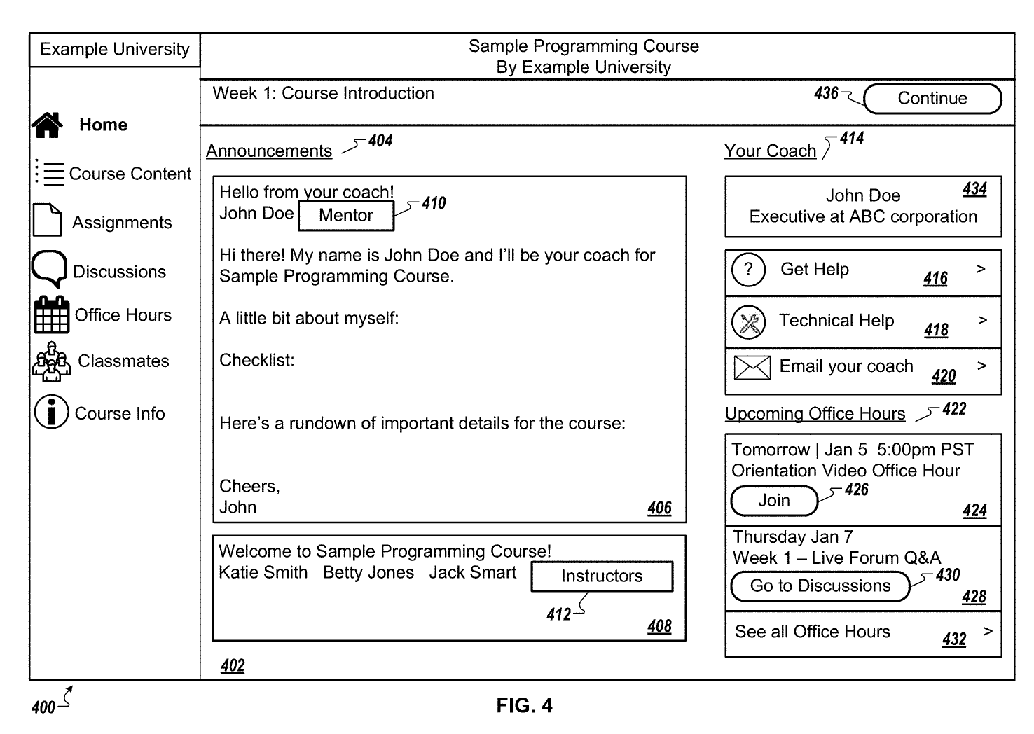

FIG. 4 is a diagram of an example user interface 400 that provides a facilitated learning interface 402 for an online course. In the example shown in FIG. 4, the facilitated learning interface 402 is shown for a Sample Programming Course by Example University for Week One of the online course (the course introduction). Similar facilitated learning interfaces can be provided for other weeks of the online course. These facilitated learning interfaces can be customized for the facilitated learning that can be provided at that point in the online course.

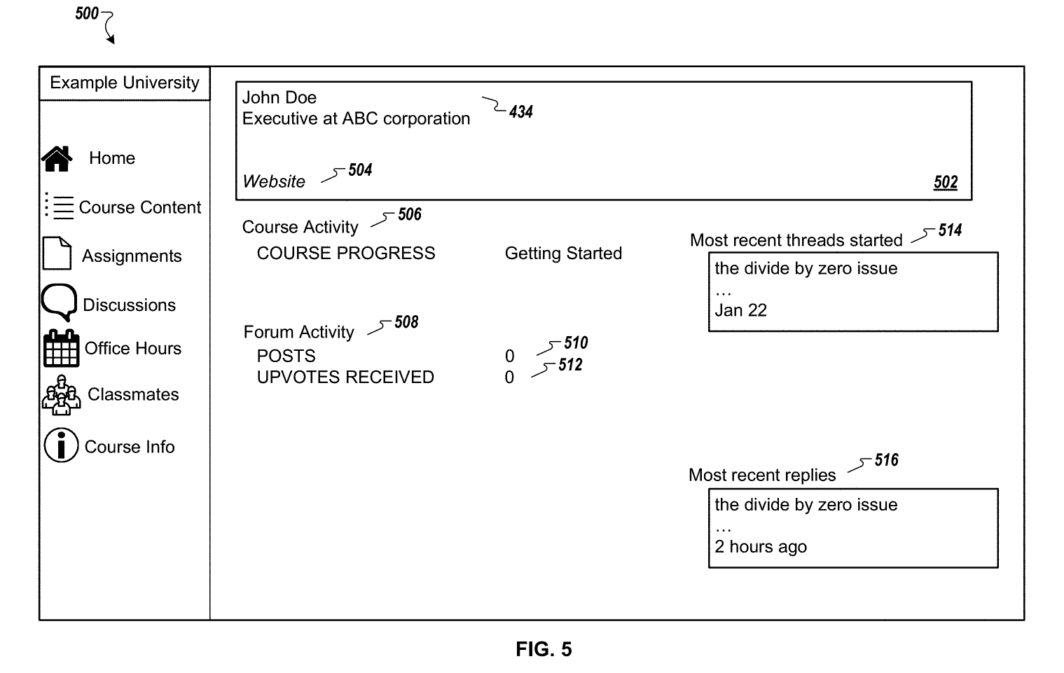

An announcements section 404 includes information about the online course. For example, the announcements section 404 can include a mentor message 406. The mentor message 406 can be from a mentor (a coach 434) for the course who will act as the mentor for the learner. The mentor message 406 can include information about the online course, information about the mentor (the coach 434), and information about materials needed for the course (e.g., books, online web site links or URLs (Uniform Resource Locators), support applications, etc.). The information can include a link or URL (mentor link 410) that if selected can redirect the learner to a web page that includes additional information about the mentor (the coach 434) that the learner will be working with while taking the online course. This will be described with reference to FIG. 5.

The announcements section 404 includes an instructor section 408. The instruction section 408 includes information about one or more instructors for the online course. The information can include a link or URL (instructor link 412) that if selected can redirect the learner to a web page that includes additional information about each instructor for the online course.

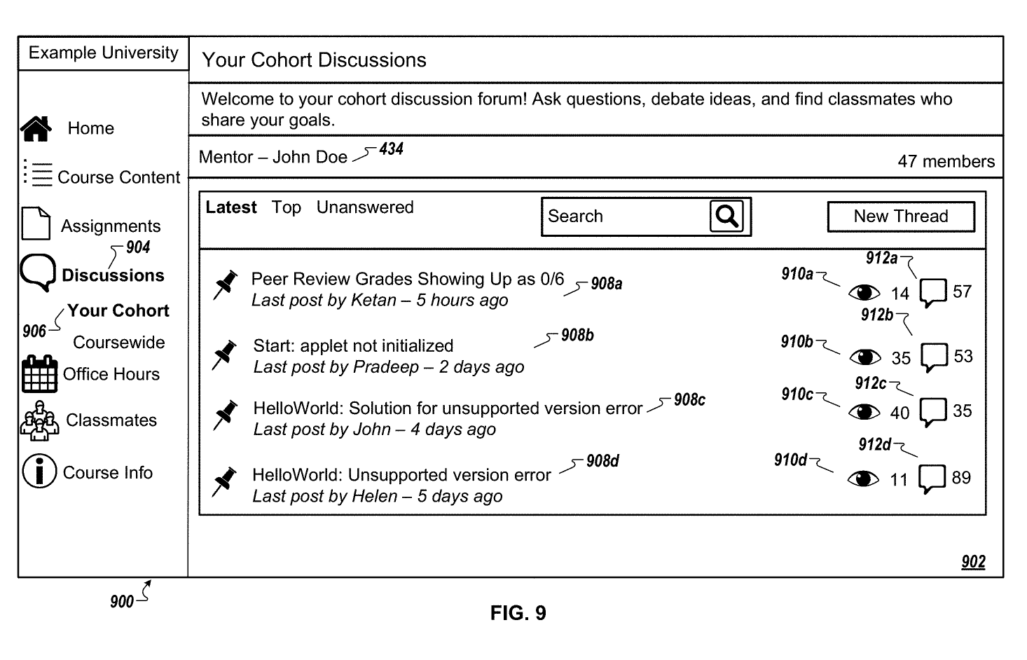

A your coach section 414 includes information about the coach 434 (the mentor) for the learner of the online course and the options available to the learner in the facilitated learning experience. The learner can select a get help option 416. When selected by the learner, the learner will be redirected to one or more web pages that include a cohort discussion for the online course. The learner can review past entries in the cohort discussion as well as add an entry to the cohort discussion. This will be described with reference to FIG. 9.

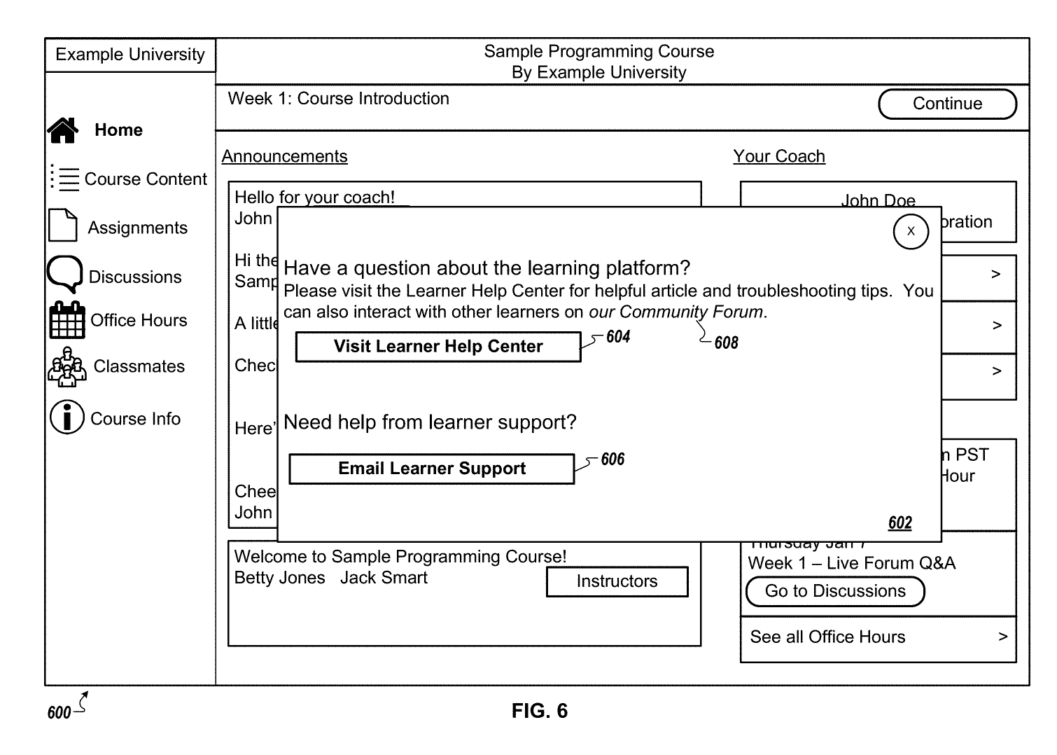

The learner can select a technical help option 418. When selected by the learner, a modal window will be displayed providing one or more online options the learner can select in order to receive the technical help that they need. This will be described with reference to FIG. 6.

The learner can select an email your coach option 420. When selected by the user, an email interface will be displayed for an email message addressed to the mentor (the coach 434). The learner can enter an issue, question, or comment in the body of the email message and send it to the mentor, who will respond promptly.

An upcoming office hours section 422 displays information and times for upcoming live interactive sessions for the online course. The upcoming office hours section 422 can also provide links to support applications, web sites, or other web pages that can be used in the interactive sessions. For example, an upcoming office hour can be an orientation video office hour 424. The listing of the orientation video office hour 424 in the upcoming office hours section 422 can include a join button 426 that, if selected by the learner, can direct the learner to the video conferencing application for use when attending the video office hour. For example, an upcoming office hour can be a live Q&A forum 428. The listing of the live Q&A forum 428 in the upcoming office hours section 422 can include a go to discussions button 430 that, if selected by the learner, can direct the learner to the application for use in participating in the live discussion forum.

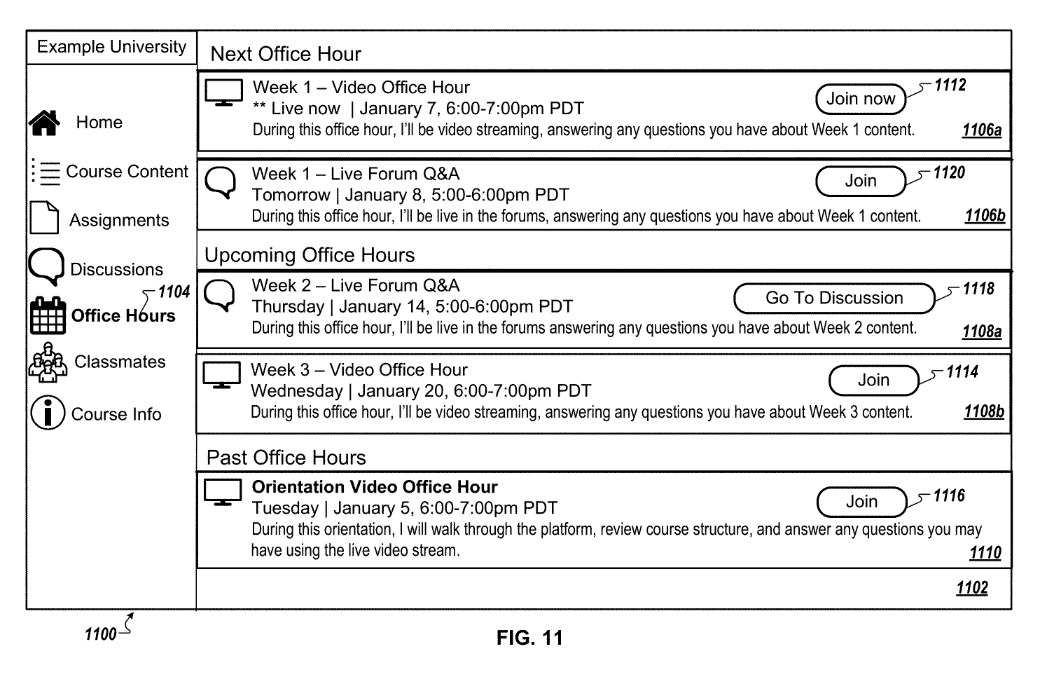

The learner can select a see all office hours option 432. When selected by the learner, a listing of all currently scheduled office hours including office hours that have already occurred (are in the past) and office hours that are scheduled to occur (are in the future). This will be described with reference to FIG. 11.

The learner can select a continue button 436 to continue with week one of the online course.

FIG. 5 is a diagram of an example user interface 500 that provides a profile 502 for a coach (e.g., the coach 434 as shown in FIG. 4). For example, referring to FIG. 4, a learner can select the mentor link 410. Upon selection of the mentor link 410, the learner is directed towards a web page that includes the user interface 500. The profile 502 can include the name of the coach, an affiliation for the coach, and background information about the coach. In addition, the profile can include a coach information link (URL) 504 that when selected by the learner can direct the learner to a web page that includes further information about the coach 434.

The profile 502 can include a course activity indicator 506. The course activity indicator 506 can provide an indication of what part of the online course is currently being offered. The course activity indicator 506 is for the online course that the learner, who is being mentored by the coach 434, is currently enrolled and participating in. In the example shown in FIG. 5, the course is in progress and is just starting.

The profile 502 can provide an indication of forum activity 508. The forum activity can include a number of posts 510 and a number of received upvotes 512 to date in the online course that the coach 434 is mentoring.

The profile 502 can include a listing of most recent threads started 514 in, for example, a discussion thread about the online course that the coach is mentoring. The profile 502 can include a listing of most recent replies 516 to, for example, a discussion thread about the online course as shown in the most recent threads started 514.

FIG. 6 is a diagram of an example user interface 600 that includes a modal window 602. Referring to FIG. 4, a learner can select the technical help option 418 and the modal window 602 can be displayed on top of (over) the user interface 400. The modal window 602 includes URLs or links (learner help center link 604 and email learner support link 606) to online options the learner can select in order to receive technical help.

For example, the learner can select the learner help center link 604. The link selection can direct the learner to a web page that can provide help for a learner such as FAQs and other links to information about the online course. For example, the learner can select the our community forum link 608. The link selection can direct the learner to a web page that can provide an online forum for question and answer exchanges between other learners enrolled in the online course. In addition, the mentor can access the forum and provide answers and guidance to learners by responding to forum questions.

For example, the learner can select the email learner support link 606. The link selection can direct the learner to a web page (or a web application) for an email application that allows the learner to send an email to learner support provided by the online course. For example, the selection of the link can launch the email application, start a draft email, and populate the “to” field of the email with the email address for learner support for the online course. In some implementations, the email address for learner support can be the email address of the mentor for the learner. In some implementations, the email address for learner support can be an email address for a centralized learner support provider for the online course.

In some cases, a learner can select a technical help option that can be provided on other user interfaces for the online course. In those cases, the modal window 602 can be displayed on top of (over) the user interface.

As part of the facilitated learning experience, the learner can receive automatically generated email reminders from the provider of the online course. The automatically generated email reminders can be for scheduled online support for the online course as part of the facilitated learning experience.

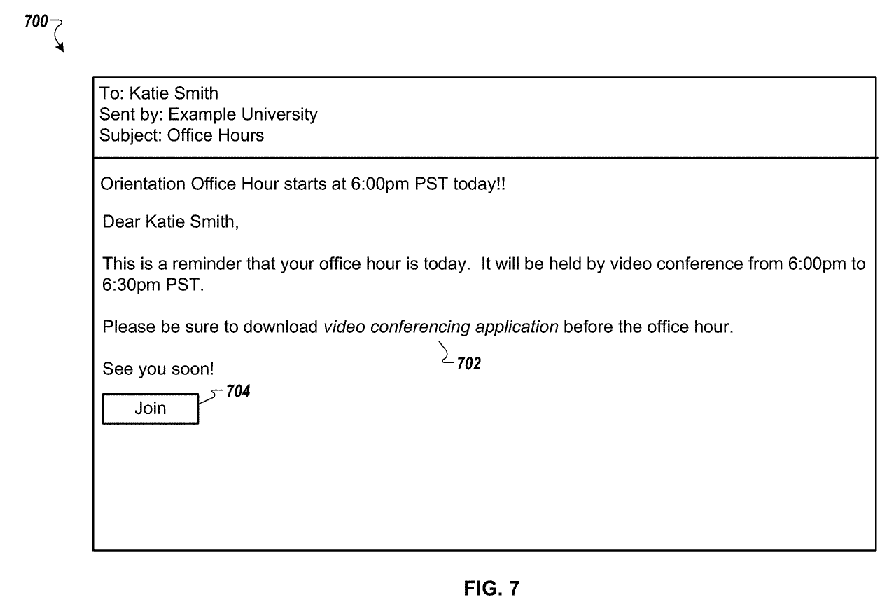

FIG. 7 is a block diagram of an example email reminder 700 for an online office hour. The email reminder 700 can be automatically generated by a course application (e.g., referring to FIG. 1, the course A application 138, the course B application 144). The email reminder 700 can include information about the date and time for the online office hour as well as what may be discussed or covered during the online office hour. Also included in the automatically generated email reminder 700 can be a link to support software and applications (video conferencing application link 702) that may be used by the learner when participating in the online office hour. The email reminder 700 includes a link to the video conference (a join link 704) for the office hour.

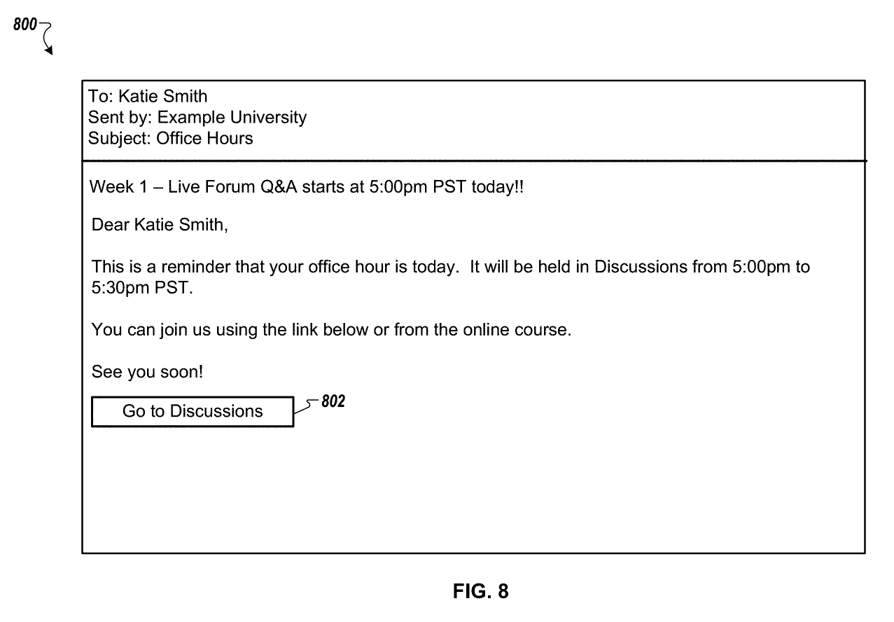

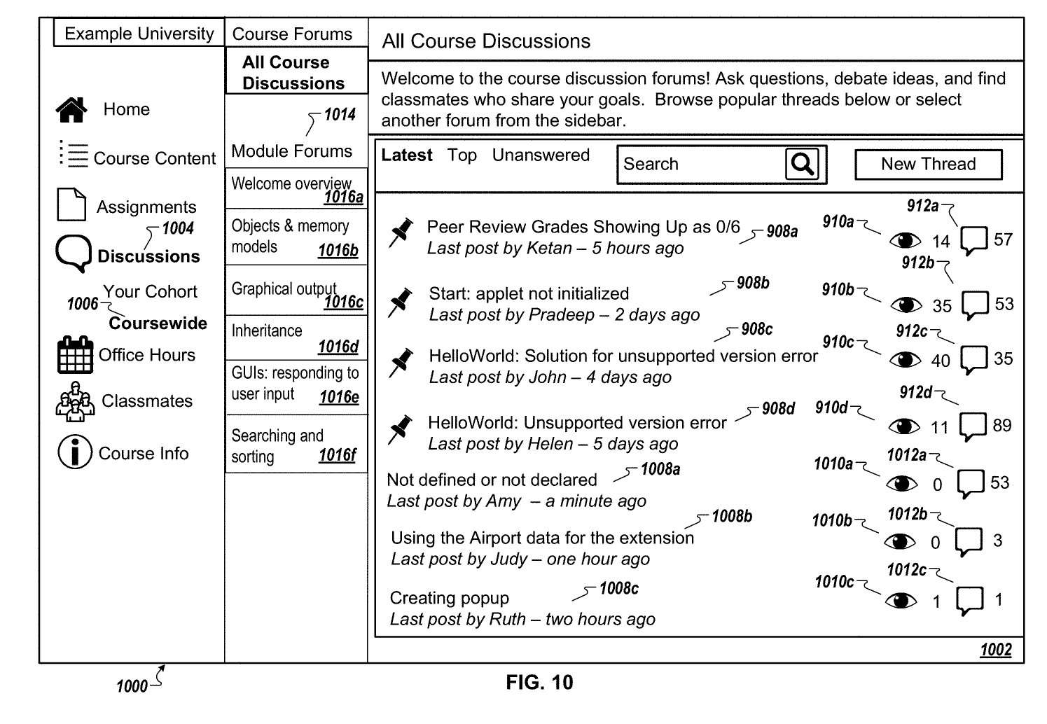

FIG. 8 is a block diagram of an example email reminder 800 for an online live question and answer forum. The email reminder 800 can be automatically generated by a course application (e.g., referring to FIG. 1, the course A application 138, the course B application 144). The email reminder 800 can include information about the date and time for the live question and answer forum. Also included in the automatically generated email reminder 700 is a link to the online forum (a go to discussions link 802). As an alternative, the learner can access the online forum from the online course. This will be shown with reference to FIGS. 9-10.

FIG. 9 is a block diagram of an example user interface 900 for a cohort discussion 902. For example, while participating in the online course, a learner can select a discussion option (or icon) 904 and a your cohort option 906 in order to display the user interface for the cohort discussion 902. The cohort discussion 902 can be an online forum for a learner to ask questions, debate ideas, and find classmates that are included in the cohort that may share the same goals as the learner.

The coach 434 for the cohort can lead the cohort discussion 902 for the learner. The coach 434 for the cohort is the mentor for the learner and is also the mentor for all learners included in the cohort. In the example shown in FIG. 9, the cohort discussion 902 includes a listing of questions and answers 908a-d posted by learners in the cohort as well as the coach 434. The cohort discussion 902 also includes, for each posting, an indication of a number of views of the posting (e.g., views 910a-d, respectively) and an indication of a number of comments on the posting (e.g., comments 912a-d, respectively).

The cohort can include a subset of the total number of learners enrolled in a session of an online course. The learners in the cohort can be selected based on one or more criterion. The criteria can include, but is not limited to, identified commons interests of the learners, geographic locations of the learners (e.g., all learners located within a particular state or country, e.g., a learner from each country), and group assignments the learners may be participating in. The mentor for the cohort is the same for each learner included in the cohort.

The cohort discussion 902 can be a live, ongoing, interactive way for a learner to give and receive help about the online course. In particular, the value of the cohort discussion forum is the ability to give and receive information about the online course on a timely basis.

FIG. 10 is a block diagram of an example user interface 1000 for a course-wide discussion 1002. For example, while participating in the online course, a learner can select a discussion option (or icon) 1004 and a coursewide cohort option 1006 in order to display the user interface for the course-wide discussion 1002. The course-wide discussion 1002 can be an online forum for a learner to ask questions, debate ideas, and find classmates that are included in the entire online course that may share the same goals as the learner.

In the example shown in FIG. 10, the course-wide discussion 1002 includes a listing of questions and answers posted by learners enrolled in the online course. In addition or in the alternative, the course-wide discussion 1002 includes a listing of questions and answers posted by one or more mentors, facilitators, instructors, or other individuals involved in the online course. As shown in the example of FIG. 10, the course-wide discussion 1002 can include postings that are also included in the cohort discussion 902 (e.g., postings 908a-d). In addition or in the alternative, the course-wide discussion 1002 includes a listing of questions and answers posted by other individuals involved in the online course (e.g., learners, mentors, facilitators, administrators, instructors, etc.). Postings 1008a-c include, for each posting, an indication of a number of views of the posting (e.g., views 1010a-c, respectively) and an indication of a number of comments on the posting (e.g., comments 1012a-c, respectively).

There can be a plurality of forums for an online course. For example, a forum can be related to a particular course topic. In another example, each week of the online course can have an associated forum. In yet another example, each project or assignment for an online course can have an associated forum. Creating topic centered course discussion forums can benefit a learner. The learner can decide which forums they prefer to participate in without having to manage and review a large number of discussion forum entries.

The user interface 1000 includes a forum module sidebar 1014. The example coursewide discussion 1002 includes popular discussion thread along with the cohort discussion threads for the learner. The learner can select another forum from the forum selections 116a-f to view and interact with postings in the respective forums that address specific topics for the online course.

The coursewide discussion 1002 can be a live, ongoing, interactive way for a learner to give and receive help about the online course that includes a vast audience for the course (e.g., learners, mentors, facilitators, administrators, instructors, etc.). In particular, the value of the course discussion forum is the ability to give and receive information about the online course on a timely basis.

FIG. 11 is a block diagram of an example user interface 1100 that provides a list of office hours 1102. For example, while participating in the online course, a learner can select an office hour option (or icon) 1104 to display the user interface 1100 that includes the list of office hours 1102 for the online course.

A mentor, a facilitator, an instructor (teacher), or any individual responsible for the administration of the online course can schedule and set up an office hour. In some implementations, a single individual will offer all of the office hours. In some implementations, more than one instructor (multiple instructors) may help teach an online course. Each instructor may be responsible for one or more weeks (sessions) of the online course. For example, an instructor responsible for a particular week of an online course may set up and schedule the office hour for that week of the online course.

The list of office hours 1102 includes a listing of next office hours (e.g., next office hours 1106a-b), a listing of upcoming office hours (e.g., upcoming office hours 1108a-b), and a listing of past office hours (e.g., past office hour 1110). The list of office hours 1102 shown in the example in FIG. 11 is one of many office hour listings that the online course application can provide. In some cases, only upcoming and past office hour listings may be provided because there are no next office hours. In some cases, for example at the beginning of the online course offering, there may be no past office hours included in the list of office hours. In addition or in the alternative, the listing of next office hours, the listing of upcoming office hours, and the listing of past office hours can each include no entries, a single entry, or a plurality of entries (two or more entries).

Each entry included in the list of office hours 1102 includes a title for the office hour, a date and a time for the office hour, a brief description of what topic(s) will be addressed during the office hour, and a link to a web page or web site where the office hour will be held. As shown in FIG. 11, for example, next office hour 1106a, upcoming office hour 1108b, and past office hour 1110 are live video streams. In each case, a link (link 1112, link 1114, and link 1116, respectively) is associated with each office hour and provided in the list of office hours for the particular office hour. A learner can select the link and begin participation in the live video stream of the office hour when the office hour is scheduled for offering. As shown in FIG. 11, for example, next office hour 1106b and upcoming office hour 1108a are live forum discussions. A link (e.g., link 1120 and link 1118, respectively) are associated each office hour and provided in the list of office hours for the particular office hour. A learner can select the link and begin participation in a live discussion forum for the office hour when the office hour is scheduled for offering.

As shown in FIG. 11, the next office hour 1106a is currently live (in session), and the learner can select the link 112 (join now) to join the live video stream for the office hour. In cases where the next office action is a discussion forum that is currently live (in session) and the learner selects a link to join the discussion forum, the learner will join the live discussion forum for the office hour. In both cases, when a learner joins a live office hour, the learner can actively participate in real time in the office hour.

As shown in FIG. 11, office hours can be live video streams and/or live participation by the facilitator of the office hour (e.g., a mentor, an instructor) in a discussion forum. As shown in the example of FIG. 11, for week one of the online course, the facilitator for that week of the online course is offering both a live video stream office hour (e.g., the next office hour 1106a) and a live discussion forum question and answer hour (e.g., the next office hour 1106b).

In some implementations, the grouping of the office hour offerings as next office hours and upcoming office hours can be based on the date scheduled for the office hour. As shown in FIG. 11, next office hour 1106a is live as of when the learner accesses the list of office hours 1102 and next office hour 1106b is during the same week but scheduled for the next day. In some implementations, the grouping of the office hour offerings as next office hours and upcoming office hours can be based on the offering for the office action. For example, if the online course is currently offering the week one session, all office hours scheduled for review or discussion of week one course content can be considered next office hours.

Providing a listing of upcoming office hours to a learner can allow the learner to plan how they will handle the course materials for a particular week of the course offering. The learner can plan such that they have done sufficient review of the course material to get the maximum benefit out of a live video stream of an office hour or a live discussion in a forum for the office hour.

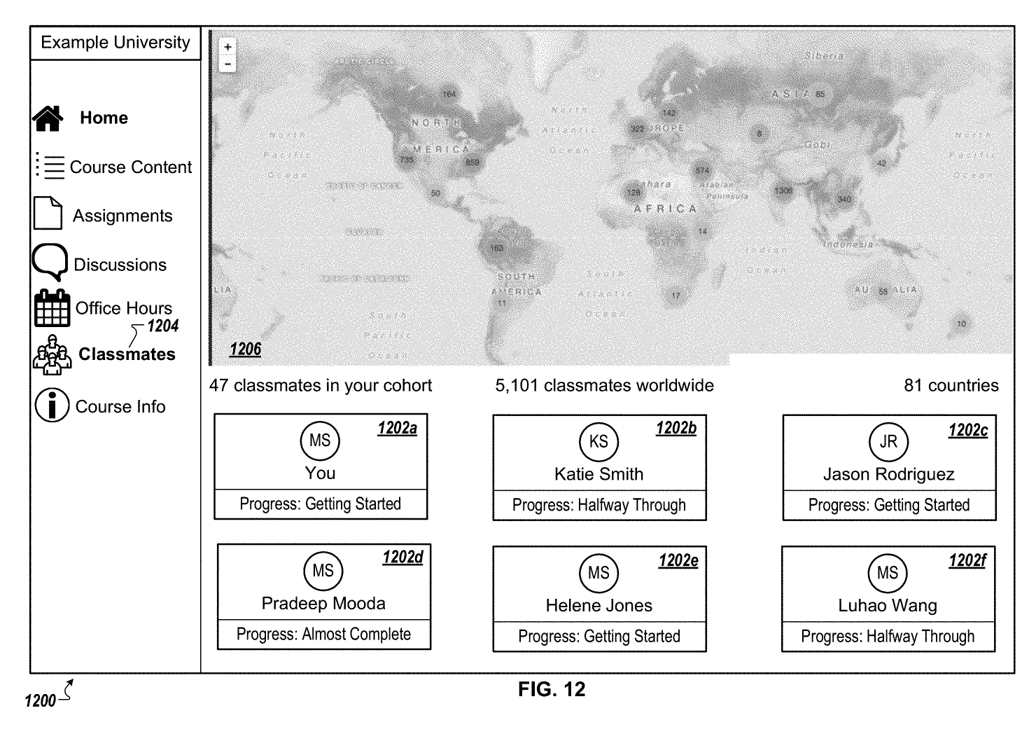

FIG. 12 is a block diagram of an example user interface 1200 that provides a list of learners 1202a-f included in a particular cohort. For example, while participating in the online course, a learner can select a classmates option (or icon) 1204 to display the user interface 1200 that includes the list of learners 1202a-f included in the same cohort as the learner. The example of FIG. 12 shows a subset of the number of classmates in the same cohort as the learner. The user interface 1200, however, can be capable of displaying more than the subset of classmates (all of the classmates included in the cohort) by allowing the learner to scroll through the list of learners. A learner can decide whether or not to be displayed as a learner in the displayed list of learners included in a particular cohort.

Included with the information about each learner in the cohort is a name for the learner and a status of the current progress of the learner in the online course. As described, learners can connect and interact with one another in discussion forums for the cohort. In some implementations, a link to an email address for a learner can be included in the listing for the learner. If a first learner selects a link for a second learner, the first learner may communicate directly with the second learner. For example, the first learner may be getting started in the online course and wants to communicate with a second learner in the same cohort for the online course who is halfway through the online course. This type of communication can be as in a classroom setting where students communicate with one another on a regular basis.

FIG. 12 includes a map 1206 that shows subsets of the total classmates in the online course and a location for each classmate subset. Learners in the online course can appreciate the scope of the worldwide learners and can also get an indication as to how many learners are in the same location (e.g., country, state, area of the world) as they are.

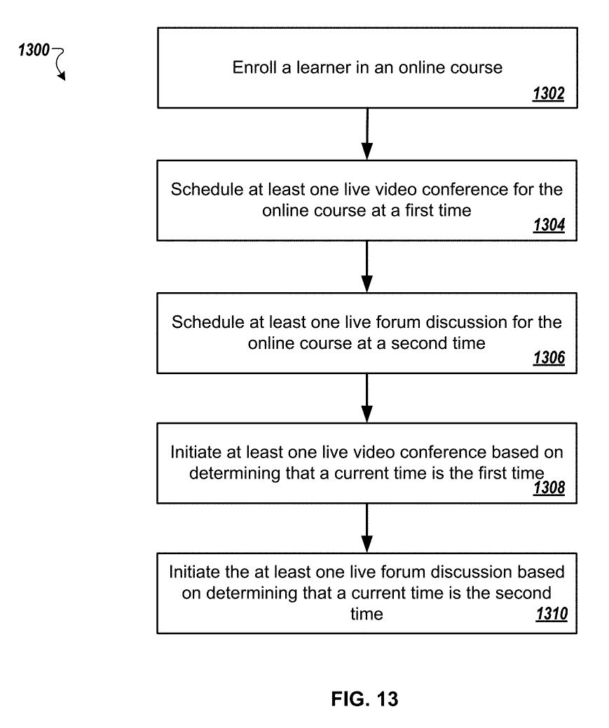

FIG. 13 is a flowchart that illustrates a method 1300 for providing facilitated learning for an online course. In some implementations, the systems described herein can implement the method 1300. For example, the method 1300 can be described referring to FIGS. 1-12.

A learner is enrolled in an online course (block 1302). For example, a course application executing on a computing system enrolls a learner in an online course Referring to FIG. 1, a learner enrolls in course A. The Course A application 138 including in the computer system 130 can receive a request from the computing device 102a by way of the network 116 to enroll the learner in the online course (course A).

At least one live video conference for the online course is scheduled at a first time (block 1304). For example, a facilitated learning module associated with the course application schedules at least one live video conference for the online course is scheduled at a first time. Referring to FIG. 1, the facilitated learning module A 140 associated with the course A application 138 can schedule at least one live video conference for the online course (course A) at a first time.

At least one live forum discussion for the online course is scheduled at a second time (block 1306). For example, the facilitated learning module associated with the course application schedules at least one live forum discussion for the online course at a second time. Referring to FIG. 1, the facilitated learning module A 140 associated with the course A application 138 can schedule at least one live forum discussion for the online course (course A) at a second time.

At least one live video conference is initiated based on determining that a current time is the first time (block 1308). For example, the facilitated learning module initiates the at least one live video conference based on determining that a current time is the first time. Referring to FIG. 1, the at least one live video conference can allow participation of the learner in the live video conference. For example, the facilitated learning module 140 associated with the course A application 138 initiates the at least one live video conference for the online course (course A).

The at least one live forum discussion is initiated based on determining that a current time is the second time (block 1310). For example, the facilitated learning module initiates the at least one live forum discussion based on determining that a current time is the second time. For example, the at least one live forum discussion can allow participation of the learner in the live forum discussion. For example, the facilitated learning module 140 associated with the course A application 138 initiates the at least one live forum discussion for the online course (course A).

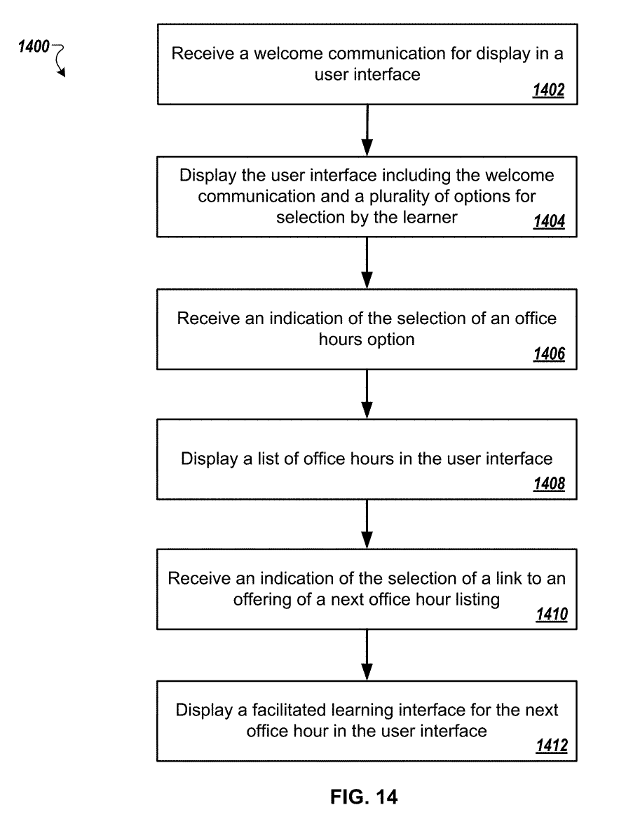

FIG. 14 is a flowchart that illustrates a method 1400 for providing facilitated learning for an online course when the online course is accessed by a computing device of a learner. In some implementations, the systems described herein can implement the method 1400. For example, the method 1400 can be described referring to FIGS. 1-12.

A welcome communication for display in a user interface is received (block 1402). For example, the computing device receives a welcome communication for display in a user interface. The user interface including the welcome communication and a plurality of options for selection by the learner is displayed (block 1404). For example, the computing device displays on a display device included in the computing device the user interface including the welcome communication and a plurality of options for selection by the learner. The user interface is included in a software application executing on the computing device. The welcome communication includes a confirmation of enrollment of a learner in the online course. For example, referring to FIG. 1, the computing device 102a can receive the welcome communication from the computer system 130 via the network 116. The computing device 102a can display the welcome communication in a user interface that can be displayed on the display device 120 included in the computing device 102a. The welcome communication can include confirmation of the enrollment of the learner in the online course (course A). The user interface can include a plurality of options for selection by the learner (e.g., a home option, a course content option, an assignment option, a discussions option, an office hours option, a classmates option, and a course info option). An example of the user interface including the welcome communication and the plurality of options for selection by the learner is shown in FIG. 4.

An indication of the selection of an office hours option is received (block 1406). For example, the computing device receives an indication of the selection of an office hours option. The office hours option is included in the plurality of options for selection by the learner. Referring to FIG. 11, the learner can select the office hours option 1104.

A list of office hours is displayed in the user interface (block 1408). For example, the computing device displays a list of office hours in the user interface. The list of office hours includes at least one of a listing of next office hours, a listing of upcoming office hours, or a listing of past office hours, each office hour listing including a link to an offering of the office hour. Each office hour listing includes a link to an offering of the office hour. Referring to FIG. 11, the user interface 1100 includes the list of office hours 1102. The list of office hours 1102 includes a listing of next office hours (e.g., the next office hours 1106a-b including link 1112 (join now) and link 1120 (join), respectively), a listing of upcoming office hours (e.g., the upcoming office hours 1108a-b including link 1118 (go to discussion) and link 1114 (join), respectively), and a listing of past office hours (e.g., the past office hour 1110 and link 1116 (join)).

An indication of the selection of a link to an offering of a next office hour listing is received (block 1410). The next office hour listing is currently in session. For example, the learner can select the link 1112 (join now). The link 1112 (join now) can direct the learner to the live video conference currently in session.

A facilitated learning interface for the next office hour is displayed in the user interface (block 1412). The facilitated learning experience allowing participation of the learner in the video conference. For example, the computing device 102a displays the live video conference for participation by the learner in the user interface displayed on the display device 120. The facilitated learning interface module(s) 112 can facilitate the participation of the learner in the live video conference.

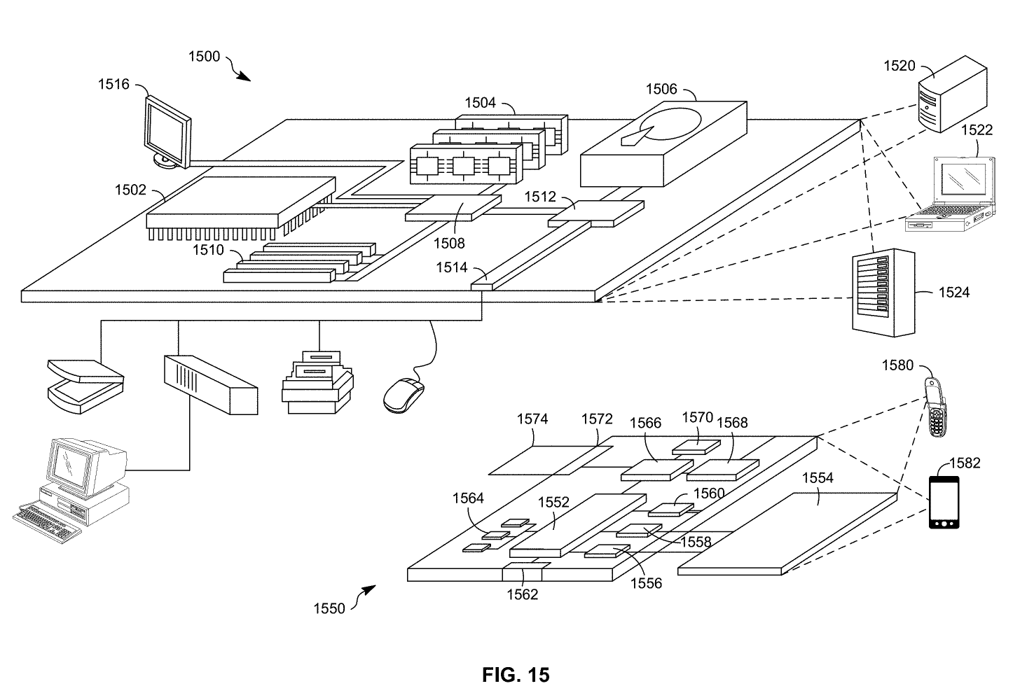

FIG. 15 shows an example of a generic computer device 1500 and a generic mobile computer device 1550, which may be used with the techniques described here. Computing device 1500 is intended to represent various forms of digital computers, such as laptops, desktops, workstations, personal digital assistants, servers, blade servers, mainframes, and other appropriate computers. Computing device 1550 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 1500 includes a processor 1502, memory 1504, a storage device 1506, a high-speed interface 1508 connecting to memory 1504 and high-speed expansion ports 1510, and a low speed interface 1512 connecting to low speed bus 1514 and storage device 1506. Each of the components 1502, 1504, 1506, 1508, 1510, and 1512, are interconnected using various busses, and may be mounted on a common motherboard or in other manners as appropriate. The processor 1502 can process instructions for execution within the computing device 1500, including instructions stored in the memory 1504 or on the storage device 1506 to display graphical information for a GUI on an external input/output device, such as display 1516 coupled to high speed interface 1508. In other implementations, multiple processors and/or multiple buses may be used, as appropriate, along with multiple memories and types of memory. Also, multiple computing devices 1500 may be connected, with each device providing portions of the necessary operations (e.g., as a server bank, a group of blade servers, or a multi-processor system).

The memory 1504 stores information within the computing device 1500. In one implementation, the memory 1504 is a volatile memory unit or units. In another implementation, the memory 1504 is a non-volatile memory unit or units. The memory 1504 may also be another form of computer-readable medium, such as a magnetic or optical disk.

The storage device 1506 is capable of providing mass storage for the computing device 1500. In one implementation, the storage device 1506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1504, the storage device 1506, or memory on processor 1502.

The high speed controller 1508 manages bandwidth-intensive operations for the computing device 1500, while the low speed controller 1512 manages lower bandwidth-intensive operations. Such allocation of functions is exemplary only. In one implementation, the high-speed controller 1508 is coupled to memory 1504, display 1516 (e.g., through a graphics processor or accelerator), and to high-speed expansion ports 1510, which may accept various expansion cards (not shown). In the implementation, low-speed controller 1512 is coupled to storage device 1506 and low-speed expansion port 1514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1500 may be implemented in a number of different forms, as shown in the figure. For example, it may be implemented as a standard server 1520, or multiple times in a group of such servers. It may also be implemented as part of a rack server system 1524. In addition, it may be implemented in a personal computer such as a laptop computer 1522. Alternatively, components from computing device 1500 may be combined with other components in a mobile device (not shown), such as device 1550. Each of such devices may contain one or more of computing device 1500, 1550, and an entire system may be made up of multiple computing devices 1500, 1550 communicating with each other.

Computing device 1550 includes a processor 1552, memory 1564, an input/output device such as a display 1554, a communication interface 1566, and a transceiver 1568, among other components. The device 1550 may also be provided with a storage device, such as a microdrive or other device, to provide additional storage. Each of the components 1550, 1552, 1564, 1554, 1566, and 1568, are interconnected using various buses, and several of the components may be mounted on a common motherboard or in other manners as appropriate.

The processor 1552 can execute instructions within the computing device 1550, including instructions stored in the memory 1564. The processor may be implemented as a chipset of chips that include separate and multiple analog and digital processors. The processor may provide, for example, for coordination of the other components of the device 1550, such as control of user interfaces, applications run by device 1550, and wireless communication by device 1550.

Processor 1552 may communicate with a user through control interface 1558 and display interface 1556 coupled to a display 1554. The display 1554 may be, for example, a TFT LCD (Thin-Film-Transistor Liquid Crystal Display) or an OLED (Organic Light Emitting Diode) display, or other appropriate display technology. The display interface 1556 may comprise appropriate circuitry for driving the display 1554 to present graphical and other information to a user. The control interface 1558 may receive commands from a user and convert them for submission to the processor 1552. In addition, an external interface 1562 may be provide in communication with processor 1552, so as to enable near area communication of device 1550 with other devices. External interface 1562 may provide, for example, for wired communication in some implementations, or for wireless communication in other implementations, and multiple interfaces may also be used.

The memory 1564 stores information within the computing device 1550. The memory 1564 can be implemented as one or more of a computer-readable medium or media, a volatile memory unit or units, or a non-volatile memory unit or units. Expansion memory 1574 may also be provided and connected to device 1550 through expansion interface 1572, which may include, for example, a SIMM (Single In Line Memory Module) card interface. Such expansion memory 1574 may provide extra storage space for device 1550, or may also store applications or other information for device 1550. Specifically, expansion memory 1574 may include instructions to carry out or supplement the processes described above, and may include secure information also. Thus, for example, expansion memory 1574 may be provide as a security module for device 1550, and may be programmed with instructions that permit secure use of device 1550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1564, expansion memory 1574, or memory on processor 1552, that may be received, for example, over transceiver 1568 or external interface 1562.

Device 1550 may communicate wirelessly through communication interface 1566, which may include digital signal processing circuitry where necessary. Communication interface 1566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1568. In addition, short-range communication may occur, such as using a Bluetooth, WiFi, or other such transceiver (not shown). In addition, GPS (Global Positioning System) receiver module 1570 may provide additional navigation- and location-related wireless data to device 1550, which may be used as appropriate by applications running on device 1550.

Device 1550 may also communicate audibly using audio codec 1560, which may receive spoken information from a user and convert it to usable digital information. Audio codec 1560 may likewise generate audible sound for a user, such as through a speaker, e.g., in a handset of device 1550. Such sound may include sound from voice telephone calls, may include recorded sound (e.g., voice messages, music files, etc.) and may also include sound generated by applications operating on device 1550.

The computing device 1550 may be implemented in a number of different forms, as shown in the figure. For example, it may be implemented as a cellular telephone 1580. It may also be implemented as part of a smart phone 1582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention. For example, each claim below and the examples of such claims described above can be combined in any combination to produce additional example embodiments.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A computer-implemented method for providing facilitated learning for an online course, the method comprising:
enrolling, by a course application executing on a computing system, a learner in the online course;
scheduling, by a facilitated learning module associated with the course application and at a first time, at least one live video conference for the online course;
scheduling, by the facilitated learning module and at a second time, at least one live forum discussion for the online course;
initiating, by the facilitated learning module, the at least one live video conference based on determining that a current time is the first time, the at least one live video conference allowing participation of the learner in the live video conference; and
initiating, by the facilitated learning module, the at least one live forum discussion based on determining that a current time is the second time, the at least one live forum discussion allowing participation of the learner in the live forum discussion.

2. The computer-implemented method of claim 1, further comprising:
generating, by the course application, a welcome communication responsive to the enrollment of the learner in the online course.

3. The computer-implemented method of claim 2, wherein the welcome communication includes at least one of confirmation of enrollment of the learner in the online course, a starting date for the online course, and a syllabus for the online course.

4. The computer-implemented method of claim 1, wherein the learner is a member of a cohort of learners, the cohort of learners being a subset of a total number of learners enrolled in the online course.

5. The computer-implemented method of claim 4, wherein the learner is enrolled in a particular session for the online course.

6. The computer-implemented method of claim 1, further comprising assigning a mentor to the learner, wherein the mentor facilitates the live video conference, and wherein the mentor facilitates the live forum discussion.

7. The computer-implemented method of claim 1, further comprising:
generating, by the facilitated learning module, a reminder about the scheduled at least one live video conference for the online course before initiating the at least one live video conference; and
sending, by the computer system and to a computing device in communication with the computer system, the reminder for display on a display device included in the computing device.

8. The computer-implemented method of claim 1, further comprising:
generating, by the facilitated learning module, a reminder about the scheduled at least one live forum discussion for the online course before initiating the at least one live forum discussion; and
sending, by the computer system and to a computing device in communication with the computer system, the reminder for display on a display device included in the computing device.

9. The computer-implemented method of claim 1, wherein initiating, by the facilitated learning module, the at least one live video conference based on determining that a current time is the first time includes:
providing, by the computer system and to a computing device in communication with the computer system, information about the live video conference, the information allowing a learner, using the computing device, to participate in the live video conference.

10. The computer-implemented method of claim 1, wherein initiating, by the facilitated learning module, the at least one live forum discussion based on determining that a current time is the second time includes:
providing, by the computer system and to a computing device in communication with the computer system, information about the live forum discussion, the information allowing a learner, interacting with the computing device, to participate in the live forum discussion.

11. A computer-implemented method for providing facilitated learning for an online course, the method comprising:
receiving, by a computing device and for display in a user interface of a software application executing on the computing device, a welcome communication confirming enrollment of a learner in the online course;
displaying, by the computing device and on a display device included in the computing device, the user interface including the welcome communication and a plurality of options for selection by the learner;
receiving, by the computing device, an indication of the selection of an office hours option included in the plurality of options for selection by the learner;
displaying, by the computing device in the user interface, a list of office hours, the list including at least one of a listing of next office hours, a listing of upcoming office hours, or a listing of past office hours, each office hour listing including a link to an offering of the office hour;
receiving, by the computing device, an indication of a selection of a link to an offering of a next office hour listing, the next office hour listing being currently in session; and
displaying, by the computing device and in the user interface, a facilitated learning interface for the next office hour, the facilitated learning interface allowing the learner to participate in the next office hour.

12. The computer-implemented method of claim 11,
wherein the learner is associated with a mentor; and
wherein the welcome communication includes a link to information about the mentor.

13. The computer-implemented method of claim 11, wherein a mentor assigned to the learner facilitates the next office hour.

14. The computer-implemented method of claim 11, wherein the next office hour is a live video conference.

15. The computer-implemented method of claim 11, wherein the next office hour is a live forum discussion.

16. The computer-implemented method of claim 11, further comprising:
responsive to receiving the indication of the selection of the office hours option:
sending, by the computing device and to a computer system, a request for the list of office hours; and
receiving, by the computing device and from the computer system, the list of office hours.

17. A non-transitory, machine-readable medium having instructions stored thereon, the instructions, when executed by a processor, cause a computing system to:
enroll a learner in an online course;
schedule, at a first time, at least one live video conference for the online course;
schedule, at a second time, at least one live forum discussion for the online course;
initiate the at least one live video conference based on determining that a current time is the first time, the at least one live video conference allowing participation of the learner in the live video conference; and
initiate the at least one live forum discussion based on determining that a current time is the second time, the at least one live forum discussion allowing participation of the learner in the live forum discussion.

18. The machine-readable medium of claim 17, wherein the learner is a member of a cohort of learners, the cohort of learners being a subset of a total number of learners enrolled in the online course.

19. The machine-readable medium of claim 17, wherein the instructions, when executed by the processor, further cause the computing system to assign a mentor to the learner, wherein the mentor facilitates the live video conference and the live forum discussion.

20. The machine-readable medium of claim 17, wherein the instructions, when executed by the processor, that cause the computing system to initiate the at least one live video conference based on determining that a current time is the first time further include instructions that cause the computing system to:
provide, to a computing device in communication with the computer system, information about the live video conference, the information allowing a learner, using the computing device, to participate in the live video conference.
